(19) United States
(12) Patent Application Publication
(10) Pub. No.: US 2008/0217923 A1
(43) Pub. Date: Sep. 11, 2008

(54) Hydraulic powered electric generator device

(76) Inventor: Jen-Yen Yen, Changhua Hsien (TW)

Correspondence Address: CHARLES E. BAXLEY, ESQUIRE, 90 JOHN STREET, SUITE 309, NEW YORK, NY, 10038, US

(21) Appl. No.: 12/080,236

(22) Filed: Apr. 1, 2008

Related U.S. Application Data
(63) Continuation-in-part of application No. 11/714,178, filed on Mar. 6, 2007.

(51) Int. Cl. F03B 13/00

(52) U.S. Cl. 290/54; 310/40 R

(57) ABSTRACT

A hydraulic powered electric generator device includes a tubular member having a housing, a partition and a receptacle secured to the housing, a paddle wheel rotatably disposed in the housing for being rotated by the water flowing through the tubular member, an electric generator disposed in the receptacle for generating the electric energy and a follower coupled to the spindle of the electric generator, and one or more magnetic members are attached to the follower and attached to the paddle wheel for allowing the follower and the electric generator to be driven by the paddle wheel and for actuating the electric generator to effectively generate an electric energy.

The present invention is a continuation-in-part of U.S. patent application Ser. No. 11/714,178, filed 6 Mar. 2007, pending.

### BACKGROUND OF THE INVENTION

1. Field of the Invention

The present invention relates to an electric generator device, and more particularly to a hydraulic powered electric generator device including a water turbine or paddle wheel powered or driven with a hydraulic force or powered or driven by the water flowing through a pipe, and an electric generator driven by the paddle wheel for generating the electric energy without attaching any sealing ring to the spindles of the paddle wheel and the electric generator, and for increasing the electric energy generating effect.

2. Description of the Prior Art

Typical water pipes provided in our house families are provided for receiving the water and for allowing the water to flow through the water pipes and to the nozzles or the required places or positions or facilities. Normally, the hydraulic force or power or energy of the water flowing through the water pipe is wasted and has not been used for generating the electric energy.

U.S. Pat. No. 4,272,686 to Suzuki discloses one of the typical energy converting devices for converting the hydraulic energy to the electric energy and comprising a water turbine and a drive wheel rotatably disposed in a power plant and coupled together with an axial tubing member for allowing the drive wheel to be rotated or driven by the water turbine, and an electric generator coupled to the drive wheel for being rotated or driven by the drive wheel.

In addition, two center partition sealing plates are required to be provided and attached to a center partition and are also required to be attached to the axial tubing member for suitably making a water tight seal between the center partition and the axial tubing member.

However, the center partition sealing plates that are engaged between the center partition and the axial tubing member may apply a great frictional force between the center partition and the axial tubing member such that the rotational speed of the water turbine and the drive wheel and the axial tubing member may be greatly reduced and such that the electric energy generating effect may be greatly reduced.

In addition, the water turbine and the drive wheel and the axial tubing member should be rotated or driven by the water power or the hydraulic force in a great rotational speed relative to the center partition and the center partition sealing plates such that a great frictional force and a great heat may be generated between the center partition sealing plates and the axial tubing member, and such that the sealing plates may be easily or quickly damaged or wormed out by the heat, and such that the water leaking problem may also be occurred or generated between the center partition sealing plates and the axial tubing member after use.

The present invention has arisen to mitigate and/or obviate the afore-described disadvantages of the conventional hydraulic powered electric generator devices.

### SUMMARY OF THE INVENTION

The primary objective of the present invention is to provide a hydraulic powered electric generator device including a paddle wheel powered or driven with a hydraulic force or powered or driven by the water flowing through a pipe, and an electric generator driven by the paddle wheel for generating the electric energy without attaching any sealing ring to the spindles of the paddle wheel and the electric generator, and for increasing the electric energy generating effect.

In accordance with one aspect of the invention, there is provided a hydraulic powered electric generator device comprising a tubular member including a bore formed therein, and including an inlet port for receiving a water, and including an outlet port for the water to flow out of the tubular member, and including a housing having a chamber formed in the housing and communicating with the bore of the tubular member for receiving the water, a partition and a receptacle secured to the housing, the receptacle including a compartment formed therein, the partition being secured between the housing and the receptacle for spacing the compartment of the receptacle and the chamber of the housing from each other, a paddle wheel rotatably disposed in the chamber of the housing with an axle for allowing the paddle wheel to be rotated and driven by the water flowing through the bore of the tubular member, at least one first magnetic member attached to the paddle wheel, an electric generator disposed in the receptacle for generating the electric energy, and including a spindle, a follower rotatably disposed in the compartment of the receptacle and coupled to the spindle of the electric generator and rotated in concert with the spindle of the electric generator, and at least one second magnetic member attached to the follower for acting with the first magnetic member of the paddle wheel and for allowing the follower and the spindle of the electric generator to be rotated and driven by the paddle wheel with the first and the second magnetic members and for actuating the electric generator to generate an electric energy.

The axle is extended from the housing and extended into the chamber of the housing for rotatably supporting the paddle wheel. The paddle wheel includes a space formed therein for receiving and supporting the first magnetic member. The paddle wheel includes a cover secured to the paddle wheel for closing the space of the paddle wheel.

The electric generator includes a pinion secured to the spindle and rotated in concert with the spindle and engaged with the follower for coupling the follower to the spindle of the electric generator. The follower includes an internal gear formed therein for engaging with the pinion and for coupling the follower to the spindle of the electric generator.

The follower includes a space formed therein for receiving and supporting the second magnetic member. The follower includes a cover secured to the follower for closing the space of the follower. The partition includes a casing formed therein for receiving the battery.

A circuit board is further provided and disposed in the compartment of the receptacle and electrically coupled to the electric generator for controlling the electric generator. One or more batteries are further provided and disposed in the compartment of the receptacle and electrically coupled to the electric generator for storing the electric energy generated by the electric generator.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a hydraulic powered electric generator device in accordance with the present invention;

FIG. 2 is a partial exploded view of the hydraulic powered electric generator device;

FIG. 3 is a perspective view of the hydraulic powered electric generator device;

FIGS. 4, 5 are cross sectional views of the hydraulic powered electric generator device taken along lines 4-4 and 5-5 of FIG. 3 respectively; and

FIG. 6 is a cross sectional view similar to FIG. 4, illustrating the operation of the hydraulic powered electric generator device.

### DETAILED DESCRIPTION OF THE PREFERRED EMBODIMENT

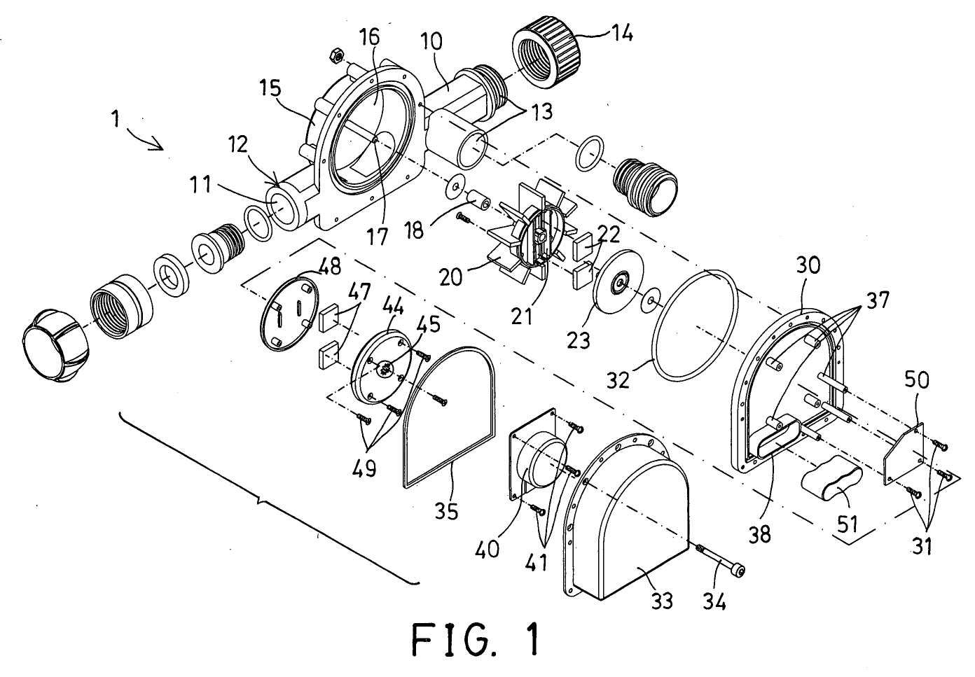

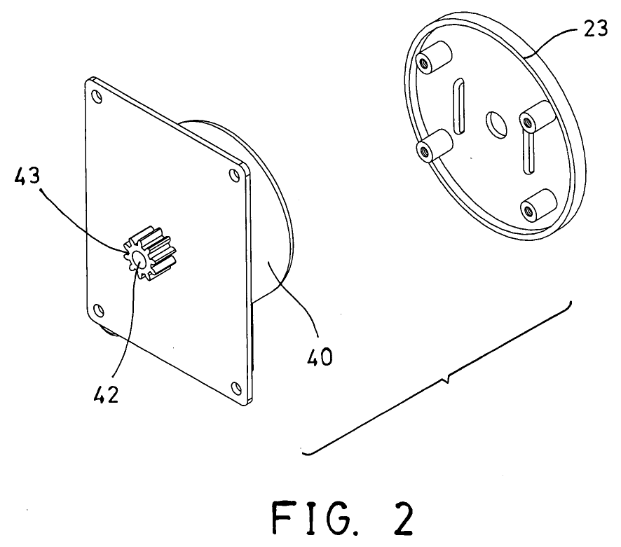

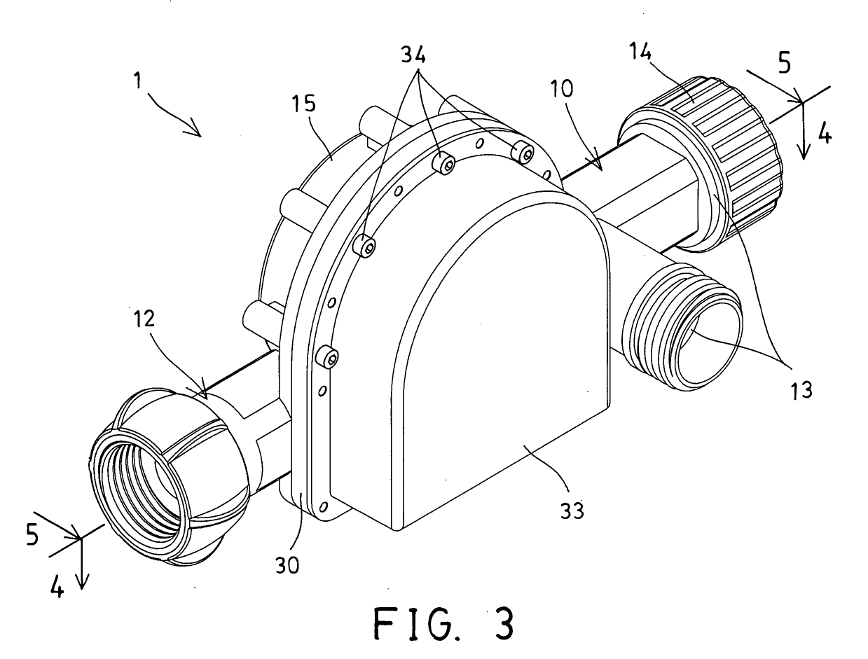

Referring to the drawings, and initially to FIGS. 1-5, a hydraulic powered electric generator device 1 in accordance with the present invention comprises a tubular member 10 including a bore 11 formed therein, and including an inlet port 12 for coupling to a water reservoir (not shown) and for receiving the water and for allowing the water to flow through the tubular member 10, and including one or more outlet ports 13 for coupling and for supplying the water to the nozzles (not shown) or the required places or positions or facilities (not shown), and for allowing the water to flow out of the tubular member 10, and including one or more caps 14 for selectively closing or blocking the outlet ports 13 of the tubular member 10.

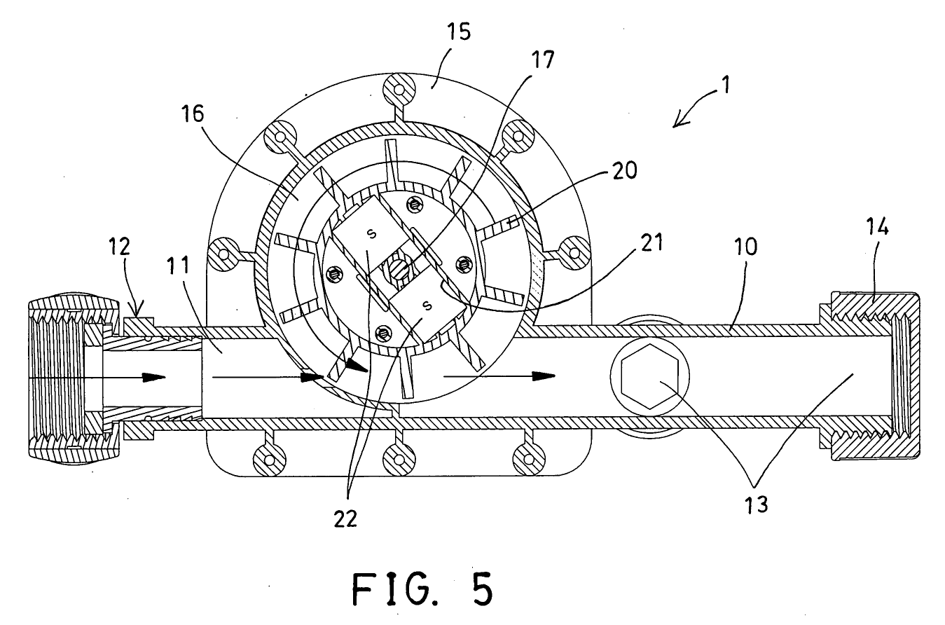

The hydraulic powered electric generator device 1 includes a housing 15 formed integral with the tubular member 10, and includes a chamber 16 formed in the housing 15 and communicating with the bore 11 of the tubular member 10 for receiving the water and for allowing the water to flow into the chamber 16 of the housing 15, and includes an axle 17 extended from the housing 15 and extended into the chamber 16 of the housing 15 for rotatably disposing or attaching or supporting a water turbine or paddle wheel 20 with one or more bearings 18 and for allowing the paddle wheel 20 to be powered or rotated or driven with the hydraulic force or power of the water flowing through the bore 11 of the tubular member 10 best shown in FIG. 5.

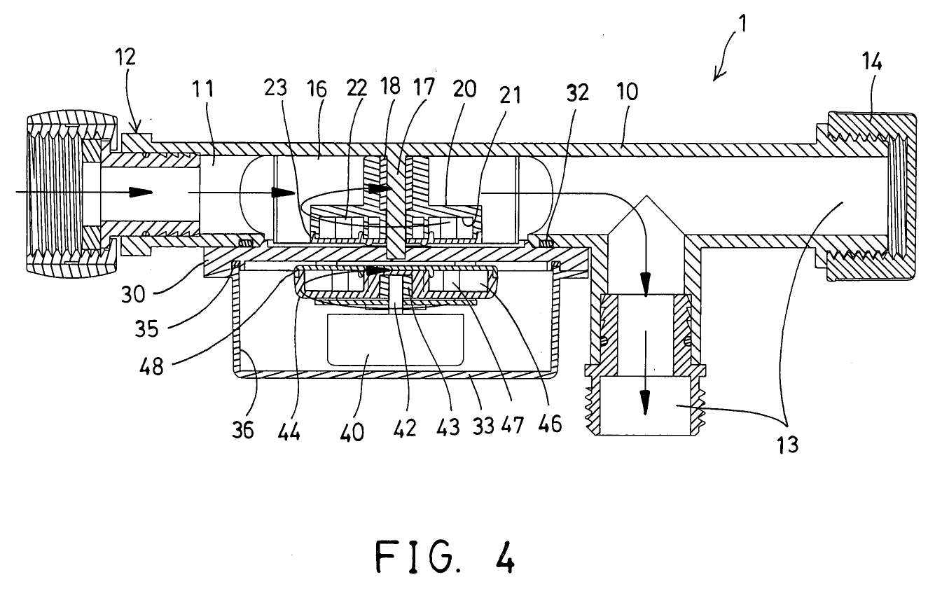

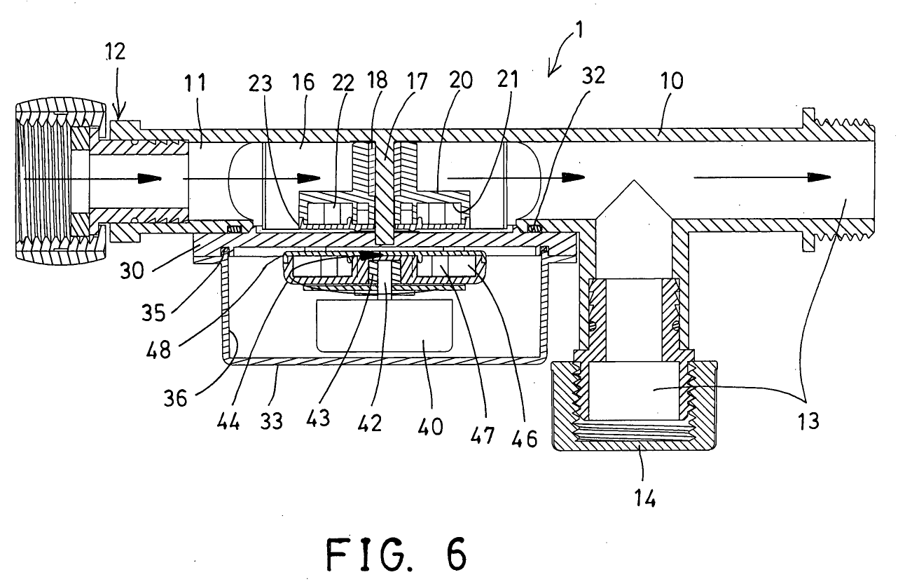

The paddle wheel 20 includes a space 21 formed therein for receiving and supporting one or more (such as two) magnetic members 22, and a cover 23 attached or secured to the paddle wheel 20 for closing or blocking the space 21 of the paddle wheel 20 and for preventing the magnetic members 22 from being wetted or rusted by the water. It is to be noted that no sealing rings are required to be provided and attached to the paddle wheel 20 and the axle 17 such that the rotational speed of the paddle wheel 20 will not be affected or reduced. A partition 30 is secured to the housing 15 with such as latches or fasteners 34, and a sealing ring 32 is provided and attached and disposed between the partition 30 and the housing 15 for making a water tight seal between the partition 30 and the housing 15 (FIGS. 4, 6).

A receptacle 33 is attached or secured to the partition 30 and/or the housing 15 with such as latches or fasteners 34, and another sealing ring 35 is provided and attached and disposed between the partition 30 and the receptacle 33 for making a water tight seal between the partition 30 and the receptacle 33, and the receptacle 33 includes a compartment 36 formed therein for receiving and attaching or supporting an electric generator 40 which may be disposed and attached or secured to the receptacle 33 with such as latches or fasteners 41 for generating the electric energy, the electric generator 40 includes a spindle 42, and a gear or pinion 43 attached or secured to the spindle 42 and rotated in concert with the spindle 42. The partition 30 may be secured between the housing 15 and the receptacle 33 and may sealingly space and separate the compartment 36 of the receptacle 33 and the chamber 16 of the housing 15 from each other.

A container or follower 44 is rotatably disposed or received in the compartment 36 of the receptacle 33, and includes a non-circular hole or internal gear 45 formed therein for engaging with the pinion 43 and for coupling the follower 44 to the spindle 42 of the electric generator 40 and for allowing the pinion 43 and the spindle 42 of the electric generator 40 to be powered or rotated or driven by the follower 44 or to be rotated in concert with the follower 44. The follower 44 includes a space 46 formed therein for receiving and supporting one or more (such as two) magnetic members 47, and a cover 48 attached or secured to the follower 44 for closing or blocking the space 46 of the follower 44 and for preventing the magnetic members 47 from being wetted or rusted by the water or the humidity.

It is to be noted that no sealing rings are required to be provided and attached to the follower 44 and the spindle 42 such that the rotational movement of the spindle 42 of the electric generator 40 will not be affected or reduced. The partition 30 may further include three or more (such as four) rollers or bearing members 37 (FIG. 1) provided therein or extended therefrom for supporting or engaging with the follower 44 and for allowing the follower 44 to be effectively rotated relative to the partition 30 and the receptacle 33 and the electric generator 40 and for allowing the spindle 42 of the electric generator 40 to be effectively rotated by the follower 44 and to generate the electric energy.

The hydraulic powered electric generator device 1 further includes a control circuit or circuit board 50 attached or secured to the partition 30 with such as latches or fasteners 31, and/or disposed in the compartment 36 of the receptacle 33 and electrically coupled to the electric generator 40 for controlling the electric generator 40, and includes one or more batteries 51, such as rechargeable batteries 51 also attached or secured to the partition 30, and/or disposed in the compartment 36 of the receptacle 33 and electrically coupled to the circuit board 50 and/or the electric generator 40 for storing the electricity generated by the electric generator 40. For example, the partition 30 includes a casing 38 formed therein for receiving the batteries 51 and for stably attaching and supporting the batteries 51 on the partition 30.

In operation, as shown in FIG. 6, when the paddle wheel 20 is powered or rotated or driven with the hydraulic force or power of the water flowing through the bore 11 of the tubular member 10, the magnetic members 47 of the follower 44 will be acted or attracted and moved by the magnetic members 22 of the paddle wheel 20 such that the follower 44 and the spindle 42 of the electric generator 40 may be rotated or driven by the paddle wheel 20 with the magnetic members 22, 47 and such that the electric generator 40 may be used to effectively generate the electric energy. No sealing rings are required to be attached to the paddle wheel 20 and the axle 17, and also no sealing rings are required to be attached to the follower 44 and the spindle 42 such that the rotational movement of the spindle 42 of the electric generator 40 and the paddle wheel 20 will not be affected or reduced.

Accordingly, the hydraulic powered electric generator device includes a paddle wheel powered or driven with a hydraulic force or powered or driven by the water flowing through a pipe, and an electric generator driven by the paddle wheel for generating the electric energy without attaching any sealing ring to the spindles of the paddle wheel and the electric generator, and for increasing the electric energy generating effect.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A hydraulic powered electric generator device comprising:
a tubular member including a bore formed therein, and including an inlet port for receiving a water, and including an outlet port for the water to flow out of said tubular member, and including a housing having a chamber formed in said housing and communicating with said bore of said tubular member for receiving the water,
a partition and a receptacle secured to said housing, said receptacle including a compartment formed therein, said partition being secured between said housing and said receptacle for spacing said compartment of said receptacle and said chamber of said housing from each other,
a paddle wheel rotatably disposed in said chamber of said housing with an axle for allowing said paddle wheel to be rotated and driven by the water flowing through said bore of said tubular member,
at least one first magnetic member attached to said paddle wheel,
an electric generator disposed in said receptacle for generating the electric energy, and including a spindle,
a follower rotatably disposed in said compartment of said receptacle and coupled to said spindle of said electric generator and rotated in concert with said spindle of said electric generator, and
at least one second magnetic member attached to said follower for acting with said at least one first magnetic member of said paddle wheel and for allowing said follower and said spindle of said electric generator to be rotated and driven by said paddle wheel with said at least one first and said at least one second magnetic members and for actuating said electric generator to generate an electric energy.

2. The hydraulic powered electric generator device as claimed in claim 1, wherein said axle is extended from said housing and extended into said chamber of said housing for rotatably supporting said paddle wheel.

3. The hydraulic powered electric generator device as claimed in claim 1, wherein said paddle wheel includes a space formed therein for receiving and supporting said at least one first magnetic member.

4. The hydraulic powered electric generator device as claimed in claim 3, wherein said paddle wheel includes a cover secured to said paddle wheel for closing said space of said paddle wheel.

5. The hydraulic powered electric generator device as claimed in claim 1, wherein said electric generator includes a pinion secured to said spindle and rotated in concert with said spindle and engaged with said follower for coupling said follower to said spindle of said electric generator.

6. The hydraulic powered electric generator device as claimed in claim 5, wherein said follower includes an internal gear formed therein for engaging with said pinion and for coupling said follower to said spindle of said electric generator.

7. The hydraulic powered electric generator device as claimed in claim 1, wherein said follower includes a space formed therein for receiving and supporting said at least one second magnetic member.

8. The hydraulic powered electric generator device as claimed in claim 7, wherein said follower includes a cover secured to said follower for closing said space of said follower.

9. The hydraulic powered electric generator device as claimed in claim 1, wherein a circuit board is disposed in said compartment of said receptacle and electrically coupled to said electric generator for controlling said electric generator.

10. The hydraulic powered electric generator device as claimed in claim 1, wherein at least one battery is disposed in said compartment of said receptacle and electrically coupled to said electric generator for storing the electric energy generated by said electric generator.

11. The hydraulic powered electric generator device as claimed in claim 1, wherein said partition includes a casing formed therein for receiving said at least one battery.
